(19) United States
(12) Patent Application Publication
(10) Pub. No.: US 2004/0252615 A1
(43) Pub. Date: Dec. 16, 2004

(54) Digital content protection

(75) Inventor: Winston Donald Keech, Whitby (GB)

Correspondence Address: WILMER CUTLER PICKERING HALE AND DORR LLP, 60 STATE STREET, BOSTON, MA, 02109, US

(73) Assignee: DarkNoise Technologies Ltd.

(21) Appl. No.: 10/460,851

(22) Filed: Jun. 13, 2003

(51) Int. Cl. G11B 7/00

(52) U.S. Cl. 369/53.21

(57) ABSTRACT

The present invention relates to digital content protection. Embodiments of the present invention provide, for example, a CD having data representing conventional audio or from which such audio can be derived using an intended target system together with data representing a spoiling component from which spoiling noise is created when the data is processed by a system other than the target system.

### FIELD OF THE INVENTION

The present invention relates to digital content protection for digital content such as, for example, content stored on CDs, DVDs, digital tapes, or in digital data files and the like.

### BACKGROUND OF THE INVENTION

There is currently a world-wide problem relating to counterfeit audio-visual consumables, such as, for example, audio and video CDs, digital tapes (e.g. DAT, DCC etc), DVDs, audio files, such as .WAV files and .MP3 files, and the like. These media or, more accurately, the data stored on such media, or contained within such files, can often be digitally copied using a computer and, optionally, a CD/DVD writer and/or a digital tape recorder without suffering any loss in quality of the audio or video derived from such data. Even sophisticated anti-copying techniques can often be avoided using relatively unsophisticated programming techniques.

Furthermore, and as outlined below, a protected digital medium or protected digital content, when converted into an analogue format e.g. an analogue audio output, is generally unprotected and may easily be copied by analogue-to-analogue or analogue-to-digital means such as a microphone and a PC soundcard.

Many techniques are known in the art for preventing digital-to-digital copying of media or data especially audio data such as, for example, music. However, in most cases audio data stored digitally using an appropriate data carrier must be converted ultimately into physical sound waves by an appropriate digital-to-analogue device for amplification and to drive conventional loudspeakers. These digital-to-analogue devices include, for example, PC soundcards and dedicated digital-to-analogue electronic circuitry in CD and DVD players etc. In the interests of quality, the sound/analogue signal produced by such devices is created as close as possible to the original medium base band recording so as to represent a reasonable facsimile of the original data. Therefore, this data (generally audio data) is then prone to being recorded or captured by an analogue device or an analogue-to-digital device such as, for example, a tape recorder or PC soundcard or the like. It would be advantageous to prevent, or at least reduce or dissuade, such copying to safeguard revenue streams for owners of recorded audio or other copyright material. This also applies to any other medium such as DVDs and the like.

It is an object of embodiments of the present invention at least to mitigate some of the problems of the prior art.

### SUMMARY OF INVENTION

Accordingly, a first aspect of embodiments of the present invention provides a storage medium comprising information (analogue data and digital data), for processing by a target output device, comprising at least information from which a human perceivable output signal can be derived, via the target output device, and information from which a spoiling component can be derived; the spoiling component being arranged to create a further human perceivable output signal when processed by a non-target output device.

Advantageously, if data representing a base band signal is copied, that is, re-recorded, the non-linearities of the recording system are exploited to move energy at predetermined frequencies to create spoiling noise. The spoiling noise is arranged to fall within the audible frequency range at a level that is perceivable by humans.

A further aspect of embodiments of the present invention relates to a data processing system comprising means for creating digital data, for a target medium and corresponding output device, comprising at least data from which an audio signal can be derived and data from which a spoiling component can be derived; the spoiling component having a frequency component arranged to create an audible frequency component.

A still further aspect of embodiments of the present invention provides a data processing method comprising the steps of creating information (analogue data and/or digital data), for processing by a target output device, comprising at least information from which a human perceivable output signal can be derived, via the target output device, and creating information from which a spoiling component can be derived; the spoiling component being arranged to create a further human perceivable output signal when processed by a non-target output device.

Preferred embodiments also provide a method comprising the step of puncturing a first digital noise signal to produce temporal or spatial discontinuities within the first digital noise signal.

Still further aspects of embodiments of the present invention provide a method in which the step of creating the first digital noise signal comprises creating a number of noise packets having respective predetermined envelopes.

Preferably, there is provided a method in which the at least one of the respective predetermined envelopes comprises at least a progressively varying attack portion having at least a predetermined rate of change of amplitude.

Preferred embodiments provide a method in which at least one of the respective predetermined envelopes comprises at least a progressively varying decay portion having a predetermined rate of change of amplitude.

Preferred embodiments provide a method further comprising the step of encoding data within or using at least some of the noise packets. Advantageously, the encoded data can be used for a number of purposes such as, for example, identifying the original of the base band signal.

Preferably, embodiments provide a method in which the data provides an indication of at least one of information associated with the digital content, information associated with a publisher of the digital content, information associated with a purchaser of the digital content.

More preferably, embodiments provide a method in which the data provides an indication of at least the composer of the digital content, a track name associated with the digital content.

Other aspects of embodiments of the present invention are described and claimed below.

### BRIEF DESCRIPTION OF THE DRAWINGS

Embodiments of the present invention will now be described, by way of example only, with reference to the accompanying drawings in which:

FIG. 1 shows a graph depicting the variation of human sensitivity to sound with both level and frequency;

FIG. 2 illustrates schematically a first principle of embodiments of the present invention, that is, translation of energy from one frequency outside of the range of human hearing to a frequency within the range of human hearing;

FIG. 3 shows a second principle used by embodiments of the present invention, that is, constructive interference or intermodulation products that combine to produce a signal within the range of human hearing that is audible;

FIG. 4 shows a further principle upon which embodiments of the present invention can rely, that is, translation of energy at frequencies within human hearing (but imperceptible to the human ear) to a frequency within human hearing to form a perceivable frequency component;

FIG. 8 shows, schematically, a process for protecting digital content according to an embodiment of the present invention;

FIG. 9 shows a number of frequency spectrums for a number of such digitally encoded spoiling components;

FIG. 10 shows a number of output spectra 1000 of the audio output by the Realistic minisette having recorded the signals corresponding to the input spectra shown in FIG. 9;

FIG. 11 shows a further principle or aspect of embodiments of the present invention for creating spoiling frequency components within the range of human hearing;

FIG. 12 shows an expanded portion of the noise packet described above with reference to FIG. 11;

FIG. 13 illustrates the effect produced by a noise packet due to an automatic level control response characteristic of an output device;

FIG. 14 illustrates the effect of such packets in conjunction, for example, with the signals represented by the fifth spectrum shown in FIG. 9;

FIG. 15 depicts a number of output spectra, that is, post re-sampling output spectra that correspond to 17.2 kHz, 18.6 kHz and 20.7 kHz noise components shown in the first to third spectra of FIG. 9;

FIG. 16 illustrates a frequency spectrum of a signal output by a recording device following sampling of a base band signal that contains spoiling noise at 17.2 kHz, 18.6 kHz and 20.7 kHz for a sampling rate of 22050 Hz;

FIG. 17 depicts a further output spectrum produced from an audio signal output by a HP Pavilion N5461 laptop computer from a base band audio signal comprising 3 spoiling frequencies 17.2 kHz, 18.6 kHz and 20.7 kHz with each of the centre frequencies having been rotated by 0.2 kHz at a frequency of 2.2 kHz; and

FIG. 18 shows a third frequency spectrum 1800 for an audio signal output by the HP pavilion computer following re-sampling, at a frequency of 22050 Hz, of an audio base band signal containing spoiling frequency components at 17.2 kHz, 18.6 kHz and 20.7 kHz each of the frequencies of which were rotated by ±0.2 kHz at a frequency of 2.2 kHz together with the above described noise packets illustrated in and described with reference to FIG. 13

### DESCRIPTION OF THE PREFERRED EMBODIMENTS

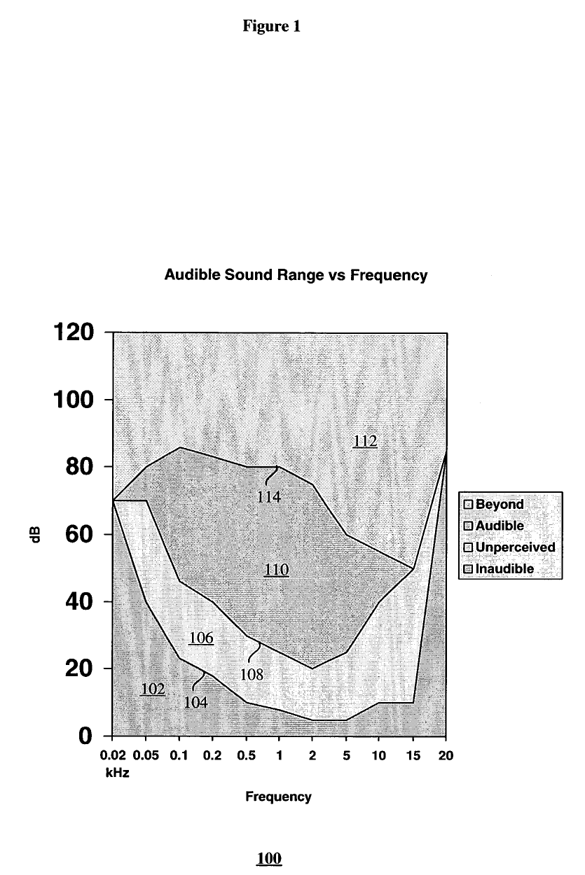

Referring to FIG. 1, there is shown a graph 100 that illustrates the human sensitivity to sound across a predetermined frequency range and for a range of loudness. The predetermined frequency range is, for the purposes of illustration, 0.02 kHz to 20 kHz. The loudness, measured in terms of decibels, is illustrated as varying from 0 dB to 120 dB. It can be appreciated that at very low and very high frequencies, sound of any magnitude is inaudible to the human ear. There is a region 102 between these very low and high frequencies where sound is completely inaudible below an inaudible sound level threshold 104 for respective volumes. There is a further region 106 where sound can be detected by the human ear but it is at or below the point or threshold 108 of perception. Sound that falls within a third region 110 is distinctly audible by the human ear. The audibility at approximately 2 to 2.5 kHz represents a range of frequencies at which human hearing exhibits maximum sensitivity. Finally, there is a further region 112 at or in which pain may be experienced by a listener. The audible region 112 and the further region 110 are separated by a boundary or threshold 114 that also varies with frequency.

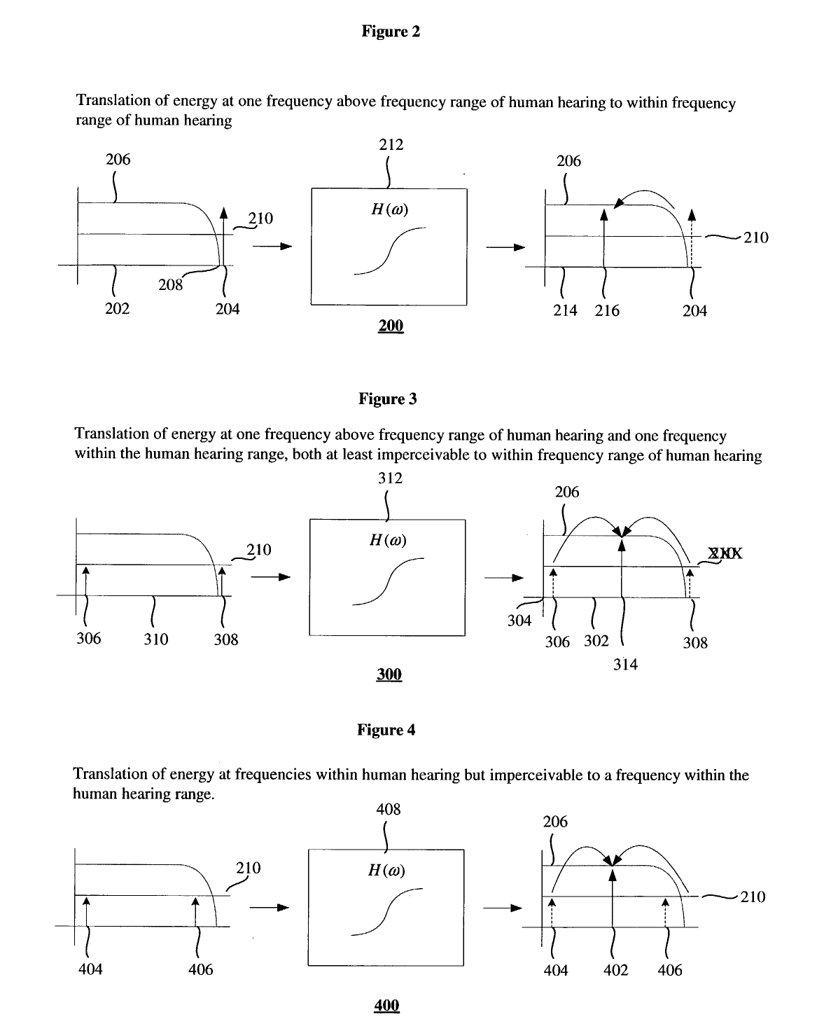

Referring to FIG. 2, there is shown a first principle upon which embodiments of the present invention can be based. The arrangement 200 of FIG. 2 shows a frequency spectrum 202 of an input signal. The input signal is illustrated for the purpose of clarity only as comprising a single noise source 204 or spoiling frequency embedded within a base band signal (not shown). Also shown is a schematic representation of the frequency response 206 of a human ear. It can be appreciated that the cut-off point 208 of the frequency response of the human ear will be substantially 20 kHz. A notional threshold 210 is also shown which corresponds to the threshold 108 as shown in FIG. 1 at which sound becomes perceivable or audible. Again, for the purpose of illustration only, this threshold 210 is shown as being substantially constant rather than varying with frequency as shown in FIG. 1.

The signal having the frequency spectrum 202 shown in FIG. 2 is processed by a non-linear system 212 having a transfer function of H(ω). The non-linear system 212 represents, for example, an analogue system that is used to re-record the sound output from an audio system (not shown), which sound has been derived from a digital source. As will be appreciated by those skilled in the art the non-linear system 212 will impose non-linear effects upon the signal having the frequency spectrum 202 illustrated. It can be seen that the frequency component 204 of the spoiling noise is beyond the frequency range of human hearing. Therefore, even though it is above the notional or schematic audible or perceivable threshold 210, it will be inaudible or imperceptible and will not, therefore, detract from any listening pleasure. However, it can be appreciated from the right hand side of FIG. 2 that the frequency spectrum 214 of the output signal comprises a frequency component 216 that is within the range of human hearing and above the perceivable threshold level 210. It can be seen that the energy of the original frequency component 204 has been translated from that frequency component 204 to the frequency component 216 so that it is perceivable by human hearing. It will be appreciated that a number of non-linear effects such as, for example, intermodulation products might give rise to such an energy transfer the first frequency component 204 to the second frequency component 216.

FIG. 3 shows an arrangement 300 similar to that shown in FIG. 2 for creating spoiling noise 302 in the spectrum 304 of an output signal from a pair 306 and 308 of frequency components of the input spectrum 310 of an input signal (not shown). It can be seen from the frequency spectrum 310 of the input signal that the pair 306 and 308 of frequency components both lie below the perceivable threshold 210. Therefore, even though these frequency components are present in the audible output and are both within the audible frequency range, they do not interfere with the listener's listening pleasure.

However, when the audible output is processed by a non-linear system 312, it can be appreciated that the energy formerly associated with the pair of frequency components 306 and 308 is transferred, by intermodulation and constructive interference, that is, by non-linear effects, to a further frequency component 314 that is located both within the frequency spectrum of human hearing 206 and such that it has a magnitude that is greater than the audible or perceivable threshold 210. Therefore, when the signal output from, for example, a Hi-fi system that is playing a CD which contains the conventional base band signal data from which conventional base bands signals for music can be derived and the spoiling components 306 and 308, the non-linear system 312 used to re-record the audible output creates a spoiling frequency component 314 that cannot be filtered without adversely effecting the reproduced base band signal. It can be appreciated that re-recording audio produced in accordance with embodiments of the present invention can be used to spoil or detract from a listener's listening pleasure.

Referring to FIG. 4, there is shown an arrangement 400 for producing a spoiling frequency 402 from a pair 404 and 406 of spoiling frequencies contained within the output of a Hi-fi system (not shown) in response to playing digital media. It can be appreciated that the spoiling frequencies 404 and 406 are both within the range of human hearing but they are also both below the perceivable threshold 210 and, as such, do not interfere with the listening pleasure of a listener.

If a non-linear system such as, for example, a tape recorder 408, is used to re-record the audio, the spoiling frequencies 404 and 406 have been selected to exploit the non-linearities of the non-linear system 408 to ensure that a relatively sizeable spoiling frequency 402 is produced, via, for example, intermodulation products, due to the transfer of energy from the spoiling frequency components 404 and 406 to that further spoiling frequency 402. It can be appreciated that the spoiling frequency 402 has a magnitude that is greater than the perceivable human hearing threshold 210 and that it falls within the frequency spectrum 206 of human hearing.

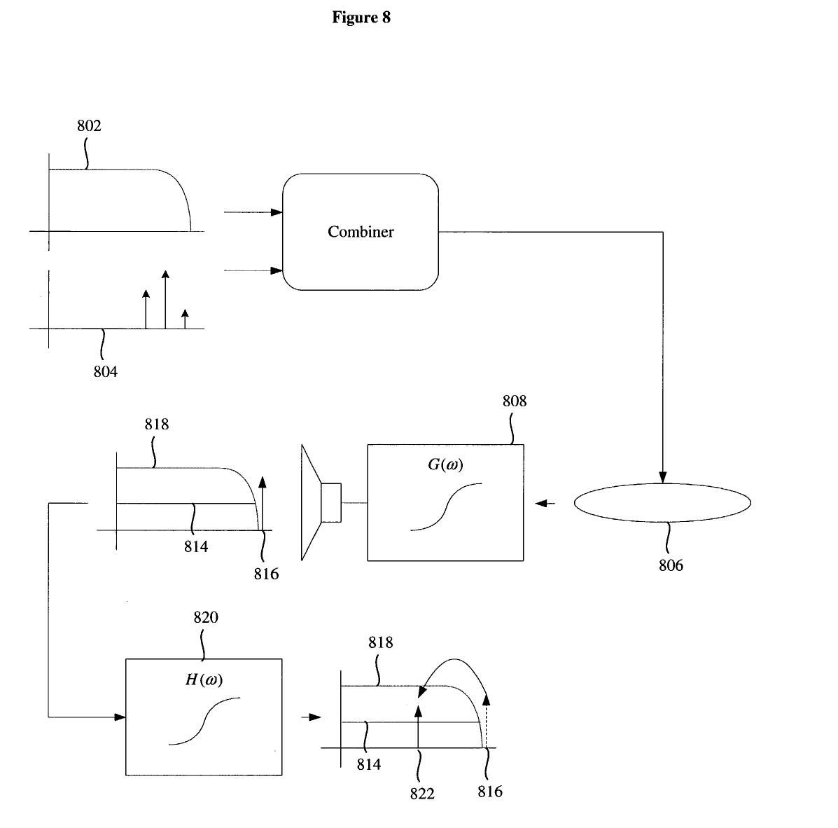

Referring to FIG. 8, there is shown, schematically a process 800 for protecting digital content according to an embodiment of the present invention. A base band audio signal 802 is combined with a source of spoiling noise (not shown). The spoiling noise has a frequency spectrum as shown by 804. The audio base band signal and the spoiling noise are combined to produce digital content which, in the illustrated example, is shown as having been stored on, for example, an optical medium such as a CD 806. When the digitised data is processed by a Hi-fi system 808, it produces, via the loud speakers 810, audio having an output spectrum 812 that comprises a faithful reproduction 814 of the original audio 802 together with a spoiling frequency component 816 that is derived from the spoiling noise shown in the spoiling noise spectrum 804. It can be appreciated that the spoiling noise or frequency component 816 falls outside of the frequency response of the human ear 818.

However, if the audio output signal is reprocessed using, for example, a tape recorder or sampled and reprocessed using a PC soundcard 820, the spoiling noise frequency component 816 has at least one of its frequency and magnitude selected to create, within the frequency response of the human ear 818, an undesirable artefact or frequency component 822.

An example of the application of the above principles of embodiments of the present invention will now be described with reference to protecting digital content against illegitimate copying using a tape recorder. In the present example the tape recorder was a “Realistic minisette-20” tape recorder which used an ordinary ferric oxide tape and the recording relied upon the built in electret condenser microphone. A blank digital audio sound file was created as the encoded source or digital content. The blank digital audio sound file only contained the spoiling components or sources of spoiling frequency components to allow the effect of each component to be assessed in the output spectrum of any signals derived from the illegitimate copy created using the Realistic minisette.

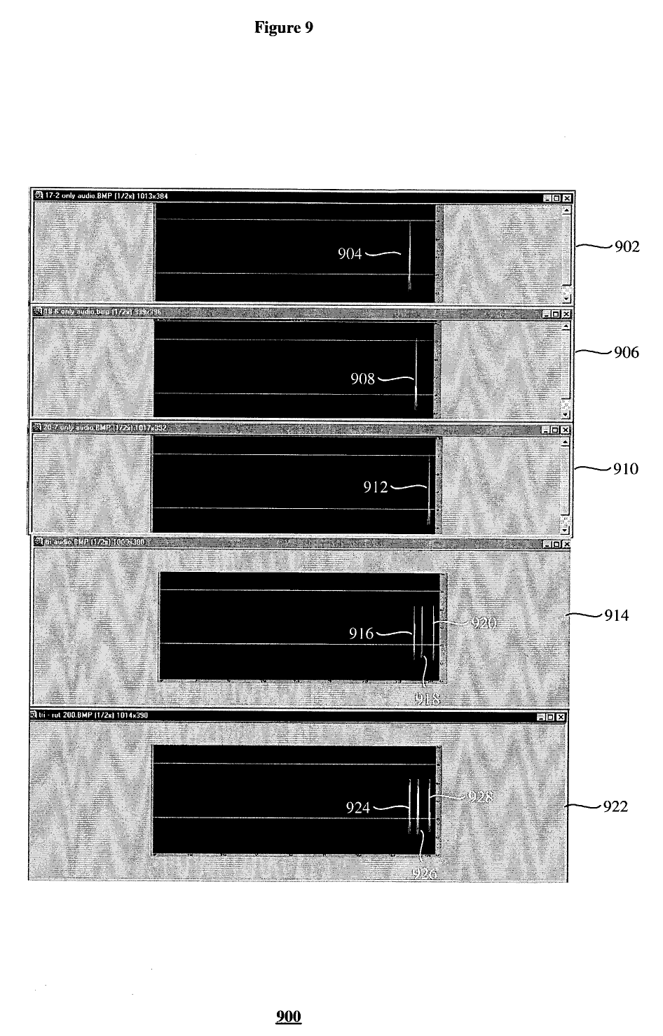

FIG. 9 shows a number of frequency spectrums 900 for a number of such digitally encoded spoiling components. The first spectrum 902 comprises a frequency component 904 having s centre a frequency of 17.2 kHz and a magnitude of about −10 dB to −12 dB. In preferred embodiments, the magnitudes are at least −20 dB and greater. A second spectrum 906 is shown for a signal having a frequency component 908 that is centred on 18.6 kHz. The magnitude of this frequency component 908 is about −10 dB to −12 dB. In preferred embodiments, the magnitude is at least −20 dB and greater. A third frequency spectrum 910 is shown as having a frequency component 912 centred on 20.7 kHz and having a magnitude of −10 dB to −12 dB. In preferred embodiments, the magnitude is at least −20 dB and, preferably, greater.

A fourth frequency spectrum 914 is also illustrated. The fourth frequency spectrum 914 comprises 3 frequency components 916 to 920 that are centred on 17.2 kHz, 18.6 kHz and 20.7 kHz. In effect, the fourth frequency spectrum 914 is a combination of the first three spectra 902, 906 and 910. Also shown is a sixth frequency spectrum 922 that represents a signal having 3 frequency components 924 to 928 centred on 17.2 kHz, 18.6 kHz and 20.7 kHz respectively. Preferably, the centre frequency of each frequency component is arranged to oscillate about the centre frequencies of 17.2 kHz, 18.6 kHz and 20.7 kHz by between ±0.1 kHz and ±0.4 kHz. In preferred embodiments, the oscillation is performed at a frequency of 2.2 kHz.

Each of the signals corresponding to the frequency spectrums 902, 906, 910, 914 and 922, having been output via a Woolworth's CD, model T-295, were recorded using the Realistic minisette 20 tape recorder to identify the effect of the frequency components 904, 908, 912, 916, 918, 920, 924, 926 and 928.

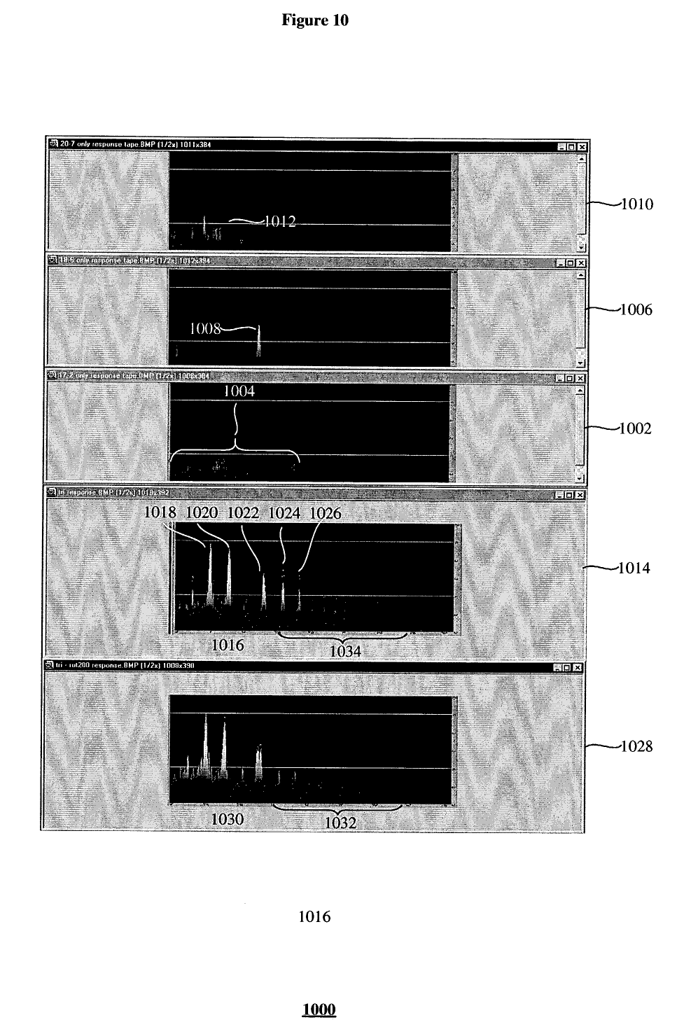

FIG. 10 shows a number of output spectra 1000 of the audio output by the realistic minisette having recorded the signals corresponding to the input spectra shown in FIG. 9. It will be appreciated that the spectra shown in FIG. 9 are input spectra from the perspective of the device used to re-record or re-process the signals corresponding to those spectra. However, the spectra shown in FIG. 9 are output spectra when viewed from the perspective of the legitimate reproduction device or target output device. The first output spectra 1002 is the spectrum produced having recorded the first input spectrum 902 with its frequency component of 17.2 kHz. It can be appreciated that much of the energy of the 17.2 kHz frequency component 904 has been redistributed to relatively low frequency and low magnitude frequency components. The magnitude of the spoiling components are between −45 dB and −55 dB for frequencies of approximately 50 Hz to 3.1 kHz together with a −45 dB peak at 4.6 kHz.

The second output spectrum 1006 corresponds to the audio signal produced in response to the tape recorder having recorded the second spectrum 906 with its 18.6 kHz frequency component 908. It can be appreciated that the spectrum 1006 comprises frequency components having magnitudes of 45 dB to −55 dB for frequencies of 60 Hz to 2 kHz together with a relatively strong −32 dB component at approximately 3.5 kHz.

It can be appreciated that a third output spectrum 1010, which corresponds to the third input spectrum 910, has a number of frequency components 1012 that are distributed over a frequency range of 40 Hz to 3.5 kHz with magnitudes of between −45 dB and −55 dB together with a relatively strong −36 dB peak at approximately 1.5 kHz. It will be appreciated that this spoiling noise or these spoiling frequency components 1012 fall squarely within the range of maximum human hearing sensitivity and have a relatively large magnitude, especially as compared to the components generated by the 17.2 kHz signal.

A fourth output spectrum 1014 is shown. The fourth output spectrum 1014 is derived from the signal having the fourth spectrum 914 shown in FIG. 9. It can be seen that the three frequency components 916 to 920 of that fourth spectrum 914 have produced a significant number of intermodulation products that are distributed over a frequency range of 5.4 kHz to 14.3 kHz. A number of the more significant intermodulation products 1016 are distributed over a frequency range of about 1 Hz to 5.4 kHz. It can be appreciated that the main frequency components 1018 to 1026 will represent significant spoiling noise that will adversely effect the listening pleasure of any illegitimate recording of an audio base band signal having spoiling frequency components 916 to 920.

A fifth frequency spectrum 1028 corresponding to the fifth input spectrum 922 is also shown in FIG. 10. Again, it can be appreciated that the fifth spectrum 1028 has a significant number of intermodulation products 1030 that fall within the frequency response of the human ear. However, as compared to the fourth spectrum 1014, it can be appreciated that the higher frequency intermodulation products 1032 have a much smaller magnitude as compared to corresponding intermodulation products 1034 of the fourth output spectrum 1014. It can be seen that much of the energy associated with the high frequency inter-modulation products 1032 has been re-focussed to lower frequencies, which has resulted in much greater average magnitudes of the frequency components in these lower frequencies.

Referring to FIG. 11, there is shown a further principle or aspect of embodiments of the present invention for creating spoiling frequency components within the range of human hearing. FIG. 11 shows a blank section of a digital base band signal 1102 that has been provided with noise in accordance with embodiments of the present invention. In particular, the main body 1104 of the signal comprises sine wave noise band encoding which, as described above, takes the form of 3 sine wave components having respective frequencies of 17.2 kHz, 18.6 kHz and 20.7 kHz together with an additional 22.05 kHz noise component. At the end of the sine wave noise band encoding section 1104, the sine wave component level is ramped down or reduced to zero as indicated by the decreasing portions 1106 of the signal 1102 prior to the introduction of a noise packet 1108 that has a very specific shape and, in preferred embodiments, comprises solely 22.05 kHz noise. Preferably, the noise packets 1108 are distributed in time throughout the base band signal 1102 either regularly or spaced so as to represent encoded information. After each noise packet 1108, the sine wave component level is ramped up or increased as indicated by signal portions 1110.

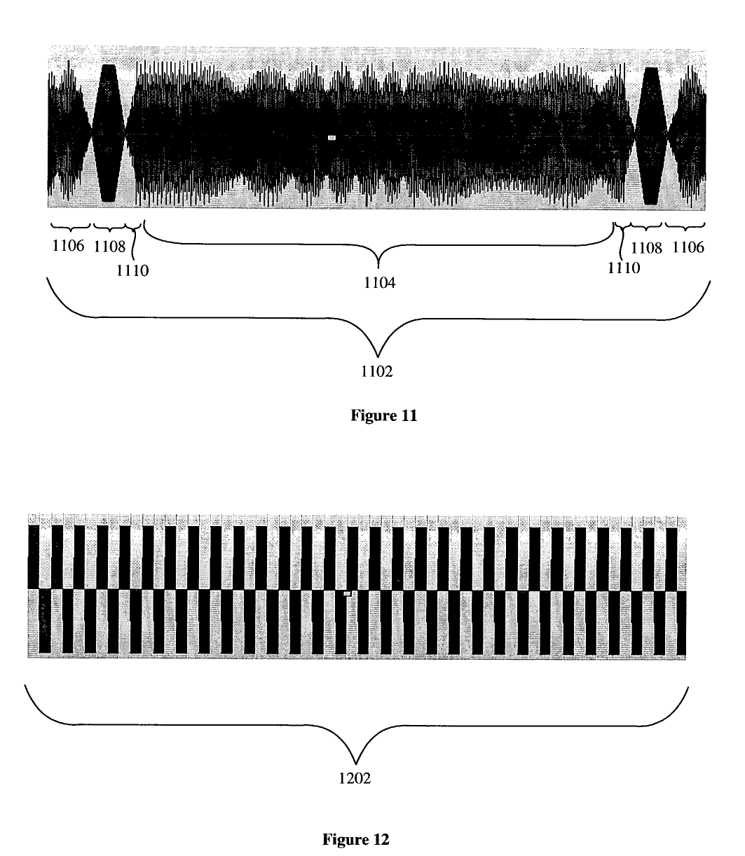

FIG. 12 shows an expanded portion 1202 of the noise packet 1108 described above with reference to FIG. 11.

It will be appreciated that FIGS. 11 and 12 show the base band signal 1102 as not containing any recorded audio information. This is in the interests of clarity and to show clearly how the noise signals are encoded. Recorded audio information is simply superimposed on and/or mixed into the noise signal shown in FIGS. 11 and 12.

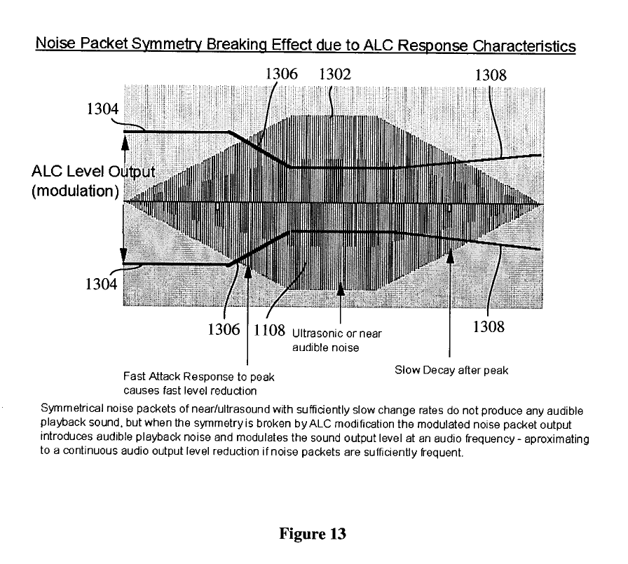

FIG. 13 illustrates the effect produced by a noise packet due to an automatic level control response characteristic of, for example, the Realistic minisette 20 tape recorder. The noise band or noise packet 1108 has a substantially symmetrical geometrical form or envelope, ramping up from 0 to a plateau 1302 and then ramping back down to 0. The solid lines 1304 show the ALC level output (a modulation) of a typical ALC circuit, giving a fast attack response to a peak leading to a fast level reduction 1306, followed by a slow decay after the peak, which then leads to a gradual level increase 1308. It will be seen that, in contrast to the symmetrical geometry of the noise packet 1108 in the base band signal 1102, the ALC response is geometrically asymmetrical. The symmetrical noise packets 1108 have sufficiently slow rates of change such that they do not produce any significant perceivable audio sound when reproduced from the original digital content by a target output device. However, when the symmetry is broken due to modification by the ALC modulation, the modulated sound packet output introduces a significant amount of noise at an audio frequency. This modulation has been found to approximate to a continuous audio output level reduction if the noise packets 1108 are sufficiently frequently distributed throughout the base band signal 1102. It will be appreciated by those skilled in the art that such a significant reduction in the average audio output level due to the packets 1108 will interfere with any listening pleasure associated with playing an illegitimate copy of digital content having such a signal 1102 embedded therein or associated therewith.

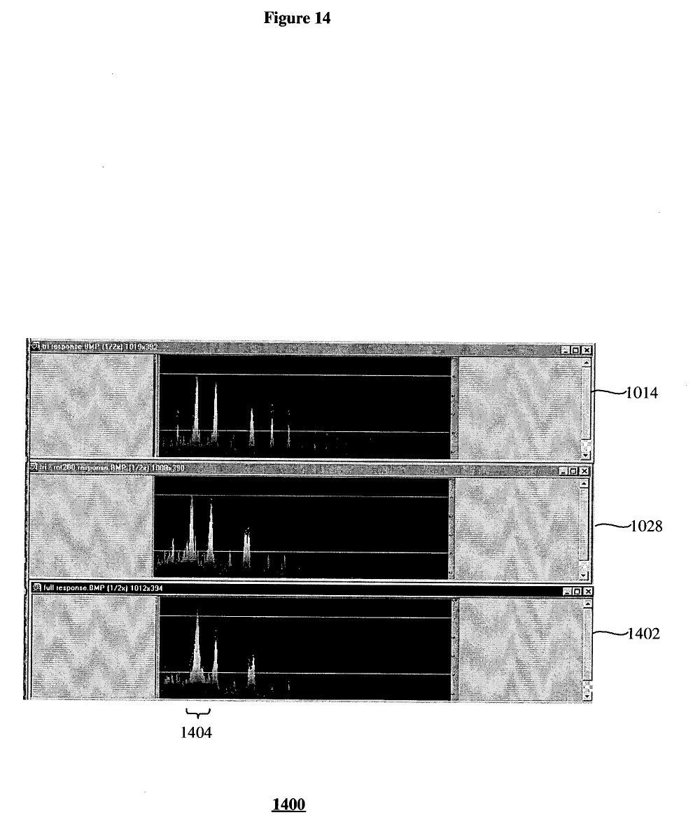

FIG. 14 shows the effect of such packets 1108 in conjunction, for example, with the signals represented by the fifth spectrum 922 shown in FIG. 9. It can be seen that the response, is very similar to the output spectrum 1028 with the exception of a slightly raised magnitude at about 40 Hz. FIG. 14 shows a number of spectra 1400 for an embodiment that used both the noise packets 1108 together with the signal having the rotating or oscillating frequency components 924 to 928 shown in the fifth spectrum 922. The output spectrum produced by such an embodiment is shown in the third spectrum 1402 of FIG. 14. The other two spectra correspond to the fourth and fifth spectra 1014 and 1028 respectively of FIG. 10 and are included for comparison purposes. It can be appreciated from the third output spectrum 1402 that there is a region 1404 having a significantly increased average power level.

A further application of embodiments of the present invention will now be described with reference to the protection of digital content stored on a CD-audio disc. In the example, the digital content stored on the CD was played on a Woolworth's T-295 personal CD player, which is a typical personal CD player. The reproduced audio signal was re-sampled using an HP Pavilion N5461 laptop computer via the audio input connection of its built in sound card at a CD quality sampling rate of 44.1 kHz using 16 bit stereo resolution. The sampled audio was replayed and its spectrum was analysed.

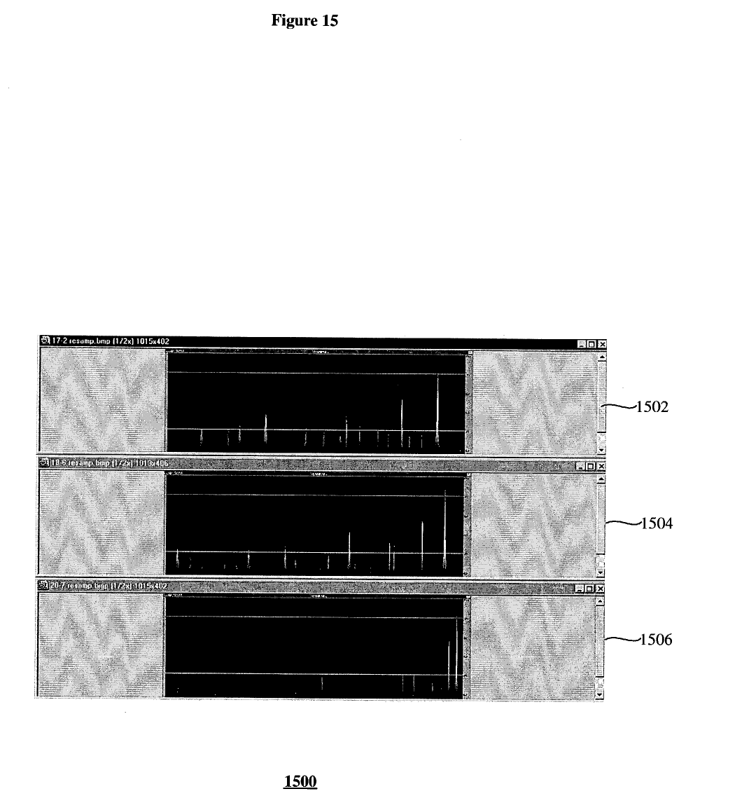

FIG. 15 shows a number of output spectra 1500, that is post re-sampling output spectra 1502, 1504 and 1506, that correspond to the 17.2 kHz, 18.6 kHz and 20.7 kHz noise components shown in the first to third 902, 906 and 910 spectra of FIG. 9.

It can be appreciated that each frequency component 904, 908 and 912 clearly manifests itself as one or more sub-harmonic tones. The magnitude of the sub-harmonic tones progressively increases with frequency but shows a marked roll-off in amplitude at 20.7 kHz. When each of the frequency components is used singularly, the tones produced are wholly unacceptable and manifest themselves as noise that is clearly heard as sub-tones.

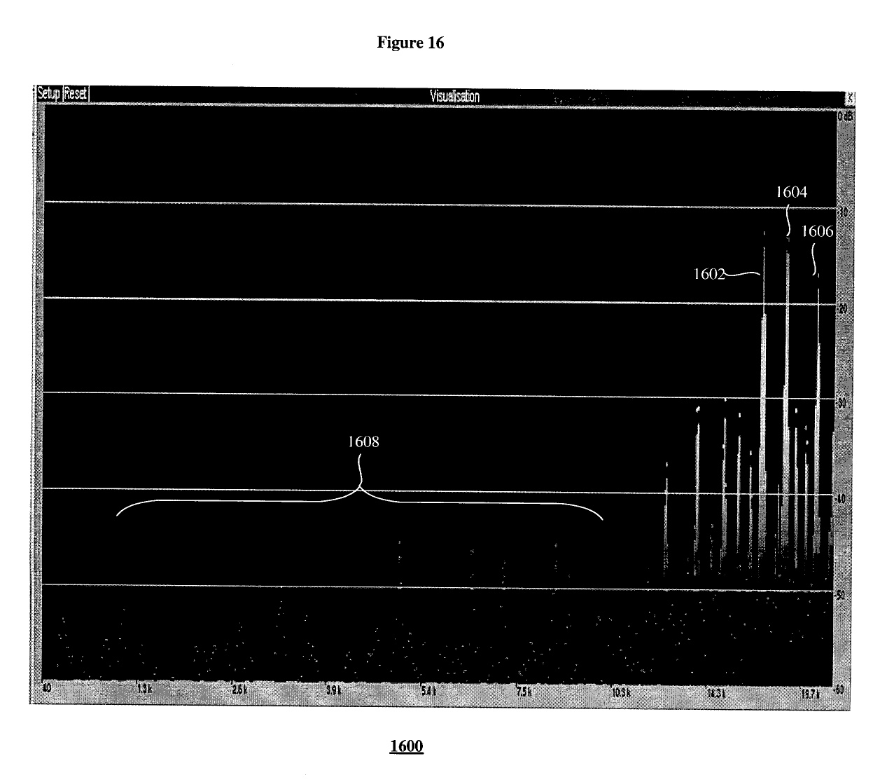

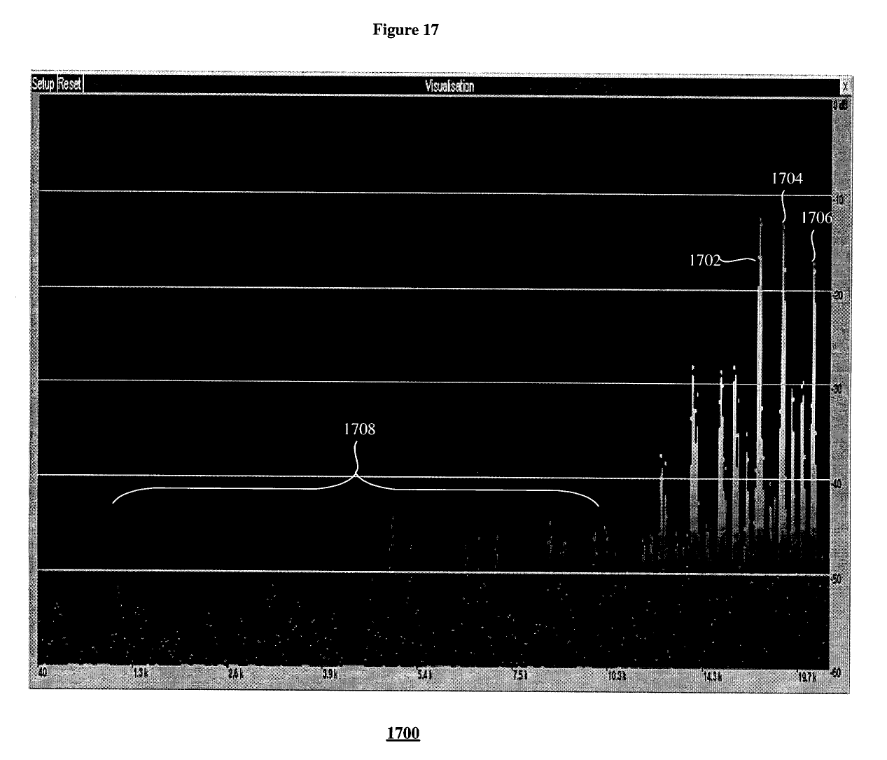

Referring to FIG. 16 there is shown a frequency spectrum of a signal output by a recording device following sampling of a base band signal that contained spoiling noise at 17.2 kHz, 18.6 kHz and 20.7 kHz at a sampling rate of 22050 Hz. The 17.2 kHz, 18.6 kHz and 20.7 kHz signal components can be clearly seen at reference numerals 1602, 1604 and 1606 respectively. It can be seen that, due to at least one of intermodulation between these frequency components 1602 to 1606 aliasing effects, a significant number of harmonics 1608, for example, are produced well within the audio range of human hearing.

Referring to FIG. 17 there is shown a further output spectrum 1700 produced from an audio signal output by the HP Pavilion N5461 laptop computer from a base band audio signal comprising 3 spoiling frequencies 1702, 1704 and 1706 that correspond to frequencies 17.2 kHz, 18.6 kHz and 20.7 kHz respectively with each of the centre frequencies having been rotated or oscillated by 0.2 kHz at a frequency of 2.2 kHz. It can be appreciated that, again, a significant number of intermodulation products and a significant degree of aliasing has resulted which causes undesirable frequency components 1708 to fall within the range of human hearing. It can be appreciated that the undesirable components 1708 have slightly greater magnitude when compared to the corresponding components 1608 of FIG. 16.

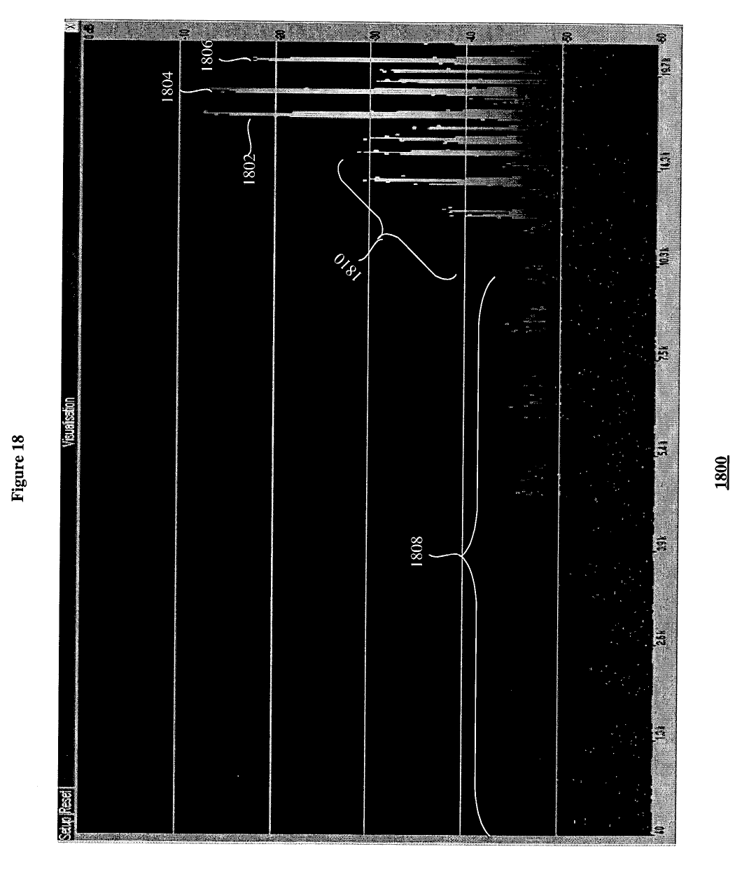

Referring to FIG. 18 there is shown a third frequency spectrum 1800 for an audio signal output by the HP pavilion computer following re-sampling, at a frequency of 22050 Hz, of an audio base band signal containing spoiling frequency components at 17.2 kHz, 18.6 kHz and 20.7 kHz, each of which were rotated by ±0.2 kHz at a frequency of 2.2 kHz, together with the above described noise packets illustrated in and described with reference to FIG. 13. It can be appreciated from the output spectrum 1800 that the 17.2 kHz, 18.6 kHz and 20.7 kHz components 1802, 1804 and 1806 respectively have relatively large magnitudes. It can also be appreciated that there is a region 1808 of appreciable spoiling noise derived from at least one of aliasing of the 17.2 kHz, 18.6 kHz and 20.7 kHz signals and intermodulation products derived from those frequencies, as well as, further aliasing caused by in adequate sampling of those intermodulation products and signals. It can also be appreciated that there is a further region 1810 of appreciable noise that is between approximately 12 kHz and 16 kHz. The noise illustrated in the output spectrum 1800 is significant and will detract from the listening pleasure of any listener.

It will be appreciated by those skilled in the art that the spoiling noise created and described with reference to the above embodiments results from at least one of the following processes

1. intermodulation products being generated from the spoiling frequency components 17.2 kHz, 18.6 kHz and 20.7 kHz signals;

2. aliasing due to an inadequate sampling frequency, that is, due to sampling at frequencies below the Nyquist frequency;

3. Moiré noise generated by, again, inadequate sampling frequencies and/or phase or sampling mismatch;

4. frequencies rotation of the spoiling components at at least one of 17.2 kHz, 18.6 kHz and 20.7 kHz as well associated intermodulation products resulting from such rotation;

5. high and low frequency noise components resulting from constructive and destructive interference between components generated via the above processes; and

6. packet asymmetry noise.

In preferred embodiments, the frequency rotation, that is, the oscillations of the centre frequency of one or more of the spoiling noise components at 17.2 kHz, 18.6 kHz and 20.7 kHz have a magnitude of between ±0.1 kHz and ±0.4 kHz and , preferably, a frequency of oscillation of 0.2 kHz. The frequency of oscillation is, preferably, between 0.01 to 0.5× the sampling frequency which, for the CD format, where the sampling frequency is 22050 Hz, gives a frequency range of 0.22 kHz to 11 kHz. In the embodiments described above, the oscillation was 2.2 kHz, that is, the frequency (22050 Hz)×0.1.

Although the above embodiments have been described with reference to producing a CD, embodiments are not limited thereto. Embodiments can equally well be realised in which DVD, digital magnetic media and computer files are created using the above.

Further more, although the embodiments described above have used substantially symmetrical noise packets, embodiments are not limited to such an arrangement. Embodiments can be realised that use substantially asymmetrical noise packets.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A storage medium comprising information, for processing by a target output device, comprising at least information from which a human perceivable output signal can be derived, via the target output device, and information from which a spoiling component can be derived; the spoiling component being arranged to create a further human perceivable output signal when processed by a non-target output device.

2. A storage medium as claimed in claim 1 in which the information from which the spoiling component is derived is not perceivable when processed by the target output device.

3. A storage medium as claimed in claim 1 in which the information from which the spoiling component is derived comprises information for creating an output signal that is not a human perceivable output signal.

4. A storage medium as claimed in claim 3 in which the output signal that is not a human perceivable output signal comprises at least one frequency component having a frequency that is above a predetermined value.

5. A storage medium as claimed in claim 4 in which the at least one frequency component comprises a respective centre frequency.

6. A storage medium as claimed in claim 5 in which the respective centre frequency is at least one of 17.2 kHz, 18.6 kHz and 20.7 kHz.

7. A storage medium as claimed in claim 5 in which the respective centre frequency is arranged to vary with time.

8. A storage medium as claimed in claim 7 in which the respective centre frequency is arranged to oscillate between predetermined upper and lower frequencies at a predetermined oscillation frequency.

9. A storage medium as claimed in claim 8 in which the predetermined oscillation frequency is between upper and lower oscillation frequencies.

10. A storage medium as claimed in claim 1 further comprising information from which a substantially symmetrical output signal can be derived; the substantially symmetrical output signal having a predetermined envelope to influence the operation of a predeterminable aspect of a non-target output device.

11. A storage medium as claimed in claim 10 in which the predeterminable aspect of the non-target output device is an automatic level control of a non-target device.

12. A storage medium as claimed in claim 10 in which the information from which a substantially symmetrical output signal can be derived comprises information from which a plurality of such substantially symmetrical output signals can be derived.

13. A storage medium as claimed in claim 12 in which the plurality of substantially symmetrical output signals are arranged on the storage medium to allow data to be derived therefrom.

14. A storage medium as claimed in claim 1 in which the medium is an optical storage medium, a storage device or a magnetic storage medium.

15. A data processing system comprising means for creating digital data, for a target medium and corresponding output device, comprising at least data from which an audio signal can be derived and data from which a spoiling component can be derived; the spoiling component having a frequency component arranged to create an audible frequency component.

16. A data processing method comprising the steps of creating information, for processing by a target output device, comprising at least information from which a human perceivable output signal can be derived, via the target output device, and creating information from which a spoiling component can be derived; the spoiling component being arranged to create a further human perceivable output signal when processed by a non-target output device.

17. A data processing method as claimed in claim 16 in which the information from which the spoiling component is derived is not perceivable when processed by the target output device.

18. A data processing method as claimed in claim 16 in which the step of creating information from which the spoiling component is derived comprises the step of creating information for producing an output signal that is not a human perceivable output signal.

19. A data processing method as claimed in claim 18 in which the output signal that is not a human perceivable output signal comprises at least one frequency component having a frequency that is above a predetermined value.

20. A data processing method as claimed in claim 19 in which the at least one frequency component comprises a respective centre frequency.

21. A data processing method as claimed in claim 20 in which the respective centre frequency is at least one of 17.2 kHz, 18.6 kHz and 20.7 kHz.

22. A data processing method as claimed in claim 20 in which the respective centre frequency is arranged to vary with time.

23. A data processing method as claimed in claim 22 in which the respective centre frequency is arranged to oscillate between predetermined upper and lower frequencies at a predetermined oscillation frequency.

24. A data processing method as claimed in claim 23 in which the predetermined oscillation frequency is between upper and lower oscillation frequencies.

25. A data processing method as claimed in claim 16 further comprising the step of creating information from which a substantially symmetrical output signal can be derived; the substantially symmetrical output signal having a predetermined envelope to influence the operation of a predeterminable aspect non-target output device.

26. A data processing method in claim 25 in which the predeterminable aspect of the non-target output device is an automatic level control of a non-target output device.

27. A data processing method as claimed in claim 25 in which the step of creating information from which a substantially symmetrical output signal can be derived comprises the step of creating information from which a plurality of such substantially symmetrical output signals can be derived.

28. A data processing method as claimed in claim 27 in which the plurality of substantially symmetrical output signals are arranged on the storage medium or in the information to allow data to be derived therefrom.

29. A data processing method as claimed in claim 16, further comprising the step of creating a storage medium storing said information

30. A data processing method as claimed in claim 29 in which the storage medium is an optical storage medium, a storage device or a magnetic storage medium.

31. A computer program comprising computer readable code to implement a method as claimed in claim 16.

32. A computer program product comprising computer readable storage storing a computer program as claimed in claim 31.
